(19) United States
(12) Patent Application Publication
(10) Pub. No.: US 2026/0208179 A1
(43) Pub. Date: Jul. 23, 2026

(54) METHOD FOR PRODUCING OXIDATION/REDUCTION CATALYST UTILIZING SULFUR ELEMENT-CONTAINING PRECURSOR AND OXIDATION/REDUCTION CATALYST PRODUCED THEREBY

(71) Applicant: KOREA INSTITUTE OF INDUSTRIAL TECHNOLOGY, Cheonan-si (KR)

(72) Inventors: Hong-Dae KIM, Ulsan (KR); Bora YE, Ulsan (KR); Bora JEONG, Daegu (KR); Myeung-jin LEE, Busan (KR); Kyung-yo PARK, Ulsan (KR)

(21) Appl. No.: 19/138,339

(22) PCT Filed: Oct. 20, 2023
(86) PCT No.: PCT/KR2023/016359

§ 371 Date: Jun. 12, 2025

(30) Foreign Application Priority Data
Dec. 28, 2022 (KR) 10-2022-0186584

(51) Int. Cl. B01J 37/34; B01D 53/86; B01J 21/06; B01J 27/051; B01J 37/02; B01J 37/04; B01J 37/08

(52) U.S. Cl. CPC B01J 37/343; B01D 53/8628; B01D 53/864; B01J 21/063; B01J 27/051; B01J 37/0213; B01J 37/04; B01J 37/08; B01D 2255/20723; B01D 2255/20769; B01D 2255/20776; B01D 2257/404; B01D 2257/502

(57) ABSTRACT

The present invention provides a method for producing a reduction catalyst utilizing a sulfur element-containing precursor, the method including: (a) a first step of preparing a mixture liquid (solution 1) containing a vanadium precursor; (b) a second step of preparing a metal sulfide dispersion (solution 2); (c) a third step of preparing a TiO₂ dispersion (solution 3); (d) a fourth step of mixing solutions 1 to 3 and then removing moisture through stirring and drying; and (e) a fifth step of conducting sintering. According to the method for producing a catalyst utilizing a sulfur element-containing precursor, a catalyst having a metal sulfide and a metal oxide coexisting as co-catalysts can be produced through the same catalyst synthesis process, by using a sulfur element-containing precursor without utilizing an expensive tungsten or molybdenum precursor.

### CROSS-REFERENCE TO RELATED APPLICATIONS

This application is the National Stage filing under 35 U.S.C. 371 of International Application No. PCT/KR2023/016359, filed on Oct. 20, 2023, which claims the benefit of Korean Patent Application No. 10-2022-0186584, filed on Dec. 28, 2022, the contents of which are all hereby incorporated by reference herein in their entirety.

### TECHNICAL FIELD

The present invention relates to a method of preparing an oxidation/reduction catalyst using a sulfur element-containing precursor and to an oxidation/reduction catalyst prepared thereby, and more specifically, to a method of preparing an oxidation/reduction catalyst having sulfur resistance properties using a WS₂ or MoS₂ precursor and to an oxidation/reduction catalyst prepared thereby.

### BACKGROUND ART

Nitrogen oxides, which account for the largest emissions among representative air pollutants, are continuously subject to environmental regulations for reducing the emissions, because they serve as main precursors of secondary fine dust. In the early 2000s, emission regulations were applied only to the Seoul Metropolitan Area in accordance with the Seoul Metropolitan Area Clean Air Conservation Act, but now, as the Special Act on the Improvement of Air Quality in Air Control Zones been legislated, emission limits for air pollutants have been designated in the central region and the southeastern zone of the southern region, and business entities subject to total emission control have been designated. Therefore, demand for the development of technologies for reducing nitrogen oxide emission is steadily increasing.

The representative nitrogen oxide reduction technology is a selective catalytic reduction technology, and V-W(Mo)/TiO₂ catalysts are mainly used based on their high efficiency of over 85% in the temperature range of 350 to 400° C., and oxidation catalysts are based on platinum catalysts and exhibit high CO and NH₃ oxidation efficiency at temperatures above 300° C. However, the presence of a small amount of SOx in the exhaust gas reduces the catalytic activity and the lifespan due to the decrease in acid sites and the formation of various salts, so there is an urgent need for the solution to this problem.

Korean Patent No. 10-1426601 uses crystalline titanium dioxide or amorphous orthotitanic acid (TiO₂·xH₂O) as a carrier, and hexavalent molybdenum (Mo⁶⁺) having an oxidation number of six is used as a cocatalyst. However, efforts are required to suppress the formation of ammonium sulfate salts, thereby improving the nitrogen oxide removal ability and improving the sulfur dioxide durability.

### DETAILED DESCRIPTION OF THE INVENTION

### Technical Problem

In order to address the above-mentioned needs, an object of the present invention is to provide a method of preparing an oxidation/reduction catalyst using a sulfur elemental-containing precursor.

In addition, another object of the present invention is to provide an oxidation/reduction catalyst prepared according to the preparation method.

### Technical Solution

To achieve the above-described object, the present invention provides a method of preparing a reduction catalyst utilizing a sulfur element-containing precursor, the method including:
(a) a first step of preparing a mixture liquid (solution 1) containing a vanadium precursor;
(b) a second step of preparing a metal sulfide dispersion (solution 2);
(c) a third step of preparing a TiO₂ dispersion (solution 3);
(d) a fourth step of mixing solutions 1 to 3 and then removing moisture through stirring and drying; and
(e) a fifth step of conducting sintering.

To achieve the above-described object, the present invention provides a sulfur element-containing reduction catalyst according to the preparation method.

To achieve the above-described object, the present invention provides a method of preparing an oxidation catalyst utilizing a sulfur element-containing precursor, the including:
(a) a first step of preparing a TiO₂ dispersion and;
(b) a second step of adding a main catalyst to the dispersion and stirring the resulting dispersion;
(c) a third step of adding a metal sulfide to the stirred dispersion and mixing the resulting mixture; and
(d) a fourth step of drying and sintering the mixture.

To achieve the above-described object, the present invention provides a sulfur element-containing oxidation catalyst according to the preparation method.

### Advantageous Effects

According to the method of preparing a catalyst utilizing a sulfur element-containing precursor, a catalyst having a metal sulfide and a metal oxide coexisting as co-catalysts can be prepared through the same catalyst synthesis process, by using a sulfur element-containing precursor without utilizing an expensive tungsten or molybdenum precursor. The extent of an oxide can be changed through sintering atmosphere control, and the preparation of a catalyst with partially existing metal sulfide phases enables the synthesis of an oxidation/reduction catalyst without any decrease in activity even in a sulfur atmosphere.

### DESCRIPTION OF THE DRAWINGS

FIG. 1 shows the results of weight change according to the sintering temperature according to one embodiment of the present invention.

FIG. 2 shows an analysis of thermal decomposition behavior before and after heat treatment according to one embodiment of the present invention.

FIG. 3A and FIG. 3B show an analysis of phase change before and after heat treatment according to one embodiment of the present invention.

FIG. 4 shows the results of evaluating NOx reduction properties according to one embodiment of the present invention.

FIG. 5A and FIG. 5B show the results of evaluating NOx reduction properties according to the sintering temperature according to one embodiment of the present invention.

FIG. 6A and FIG. 6B show the results of evaluating CO oxidation properties according to the sintering temperature according to one embodiment of the present invention.

### MODES OF THE INVENTION

Hereinafter, the present invention will be described in more detail.

According to one aspect of the present invention, there is provide a method of preparing a reduction catalyst utilizing a sulfur element-containing precursor, the method including: (a) a first step of preparing a mixture liquid (solution 1) containing a vanadium precursor; (b) a second step of preparing a metal sulfide dispersion (solution 2); (c) a third step of preparing a TiO₂ dispersion (solution 3); (d) a fourth step of mixing solutions 1 to 3 and then removing moisture through stirring and drying; and (e) a fifth step of conducting sintering.

When a catalyst used for reduction and oxidation reactions is exposed to a gas atmosphere containing sulfur, its catalytic activity decreases due to a competitive reaction with ammonia at an acid site, or its catalytic lifespan is shortened due to the formation of various salts such as ammonium bisulfate and ammonium sulfate. Therefore, in the present invention, when preparing a NOx reduction catalyst and a CO oxidation catalyst, a sulfur-containing precursor is used to impart durability against sulfur and prevent an activity decrease in a SO₂ atmosphere. The sulfur-containing precursor serves a cocatalyst for both oxidation and reduction catalysts to extend the temperature range of catalytic activity. The sulfur-containing precursor (metal sulfide) usable in the present invention may be one or more selected from sulfides such as CuS, RuS₂, ReS₂, ZnS, SnS, NiS, MnS, FeS, WS₂, and MoS₂, preferably RuS₂, ReS₂, WS₂, and MoS₂, and more preferably WS₂ and MoS₂.

The method of preparing the reduction catalyst of the present invention uses an impregnation method, and the preparation sequence is as follows. First, three different solutions (solutions 1 to 3) are prepared. Solution 1 is prepared by dissolving oxalic acid in an ethanol solvent set to a temperature condition of 50 to 70° C., and then adding 1% to 3% by weight ammonium metavanadate (AMV), which is a vanadium precursor. Solution 2 is prepared by adding 1% to 10% by weight of a metal sulfide to an ethanol solvent and prepare a dispersion by tip sonication. At this time, the metal sulfide may be one or more selected from sulfides such as CuS, RuS₂, ReS₂, ZnS, SnS, NiS, MnS, FeS, WS₂, and MoS₂. Solution 3 is prepared by dispersing 98% to 87% by weight of TiO₂ in an ethanol solvent.

Next, solutions 1 to 3 are stirred for 20 to 40 minutes, then mixed together and tip-sonicated for 30 to 90 minutes to disperse and mix in a solvent. Thereafter, the mixture is stirred for one to three hours and stirred at a temperature of 90 to 110° C. using an oil bath to evaporate all the solvent.

Next, the completed cake form is dried at a temperature of 90 to 110° C. for 10 to 14 hours to remove all remaining moisture. Thereafter, the cake form is sintered at a temperature of 300 to 500° C. for one to three hours to prepare a powdered catalyst.

When sintering is performed at a temperature below 300° C., the cocatalyst and main catalyst precursors may not be sufficiently oxidized into oxides and thus may not exhibit efficiency as a catalytically active material. In particular, since a metal sulfides is present as a sulfide, the sulfide may be oxidized in the catalytically active temperature range of 300° C. or higher and emit SO₂. When sintering is performed at a temperature above 500° C., crystallization may occur as sintering of the catalytically active material occurs, and the catalytic efficiency may decrease as the specific surface area of the support, TiO₂, is drastically reduced.

According to another aspect of the present invention, there is provided a reduction catalyst according to the method of preparing the reduction catalyst. Unlike a conventional NOX reduction catalyst using a commercial ammonium meta tungstate (AMT), the reduction catalyst of the present invention has a sulfur component on the surface thereof, and therefore, even under low temperature conditions of 220 to 300° C., preferably about 220 to 250° C., in an SO₂ atmosphere, the NOx conversion is 95% to 100%. Compared to a conventional V-W(Mo)/TiO₂ catalyst having an efficiency of 85% or more in a temperature range of 350 to 400° C., the reduction catalyst of the present invention exhibits higher NOx reduction efficiency at a low temperature of about 200° C.

In addition, the activity of the catalyst is also affected by the sintering temperature during catalyst preparation. When a catalyst using a metal sulfide is sintered temperature of 400 to 500° C., the NOx conversion is 80% to 100% in a temperature range of 220 to 400° C. in a SO₂ atmosphere. According to one embodiment of the present invention, when a catalyst prepared by adding MoS₂ is sintered under a temperature condition of 400 to 500° C., the NOx conversion is 80% to 100% in a temperature range of 220 to 300° C. in a SO₂ atmosphere. Preferably, the NOx conversion is 90% to 100% in a temperature range of 250 to 300° C. Since MoS₂ causes a problem of converting NO to N₂O by one of the side reactions, using it at a temperature of 380° C. or lower is preferable because N₂O generation may be a problem at a high temperature of 400° C. When a catalyst prepared by adding WS₂ is sintered under a temperature condition of 400 to 500° C., the NOx conversion is 90% to 100% in a temperature range of 220 to 400° C. in a SO₂ atmosphere. Preferably, the NOx conversion is 90% to 100% even under a low temperature condition of 220 to 250° C.

According to still another aspect of the present invention, there is provided a method of preparing a reduction catalyst utilizing a sulfur element-containing precursor, the method including: (a) a first step of preparing a mixture liquid (solution 1) containing a vanadium precursor; (b) a second step of preparing a metal sulfide dispersion (solution 2); (c) a third step of preparing a TiO₂ dispersion (solution 3); (d) a fourth step of mixing solutions 1 to 3 and then removing moisture through stirring and drying; and (e) a fifth step of conducting sintering.

Like the method of preparing the reduction catalyst, the method of preparing the oxidation catalyst of the present invention also uses an impregnation method, and the preparation sequence is as follows. First, in order to remove residual moisture and impurities on the surface of anatase TiO₂, it is dried for 10 to 14 hours under a temperature condition of 80 to 120° C.

Next, TiO₂ in a fixed amount of 89% to 96.95% by weight is dispersed in deionized water to form a titanium oxide solution. Thereafter, a Pt precursor, H₂Cl₆Pt·xH₂O main catalyst, in an amount of 0.05% to 1% by weight is dissolved in the titanium oxide solution to prepare a Pt/TiO₂ mixture solution, which is stirred for one to three hours under a temperature condition of 50 to 70° C. Thereafter, a metal sulfide in an amount of 3% to 10% by weight is dispersed in deionized water, and tip sonication is performed for 5 to 20 minutes to improve the dispersibility. At this time, the metal sulfide may be one or more selected from sulfides such as CuS, RuS₂, ReS₂, ZnS, SnS, NiS, MnS, FeS, WS₂, and MoS₂.

Next, the Pt/TiO₂ mixture solution and the metal sulfide dispersion are mixed together, and tip sonication is additionally performed for 30 to 90 minutes. Thereafter, the residual moisture is removed by drying under a temperature condition of 100 to 120° C. for 10 to 14 hours using an oil bath. Thereafter, a powder catalyst is obtained by sintering under a temperature condition of 300 to 500° C. for one to three hours. At this time, Pt/TiO₂ supported with metal sulfide (MS₂) is 0.1 Pt-xMS₂/TiO₂_y, where x is 3% to 10% by weight and y is 300 to 500° C.

According to yet another aspect of the present invention, there is provided an oxidation catalyst according to the method of preparing the oxidation catalyst. The activity of the catalyst is also affected by the sintering temperature during the preparation of the catalyst. When a catalyst using a metal sulfide is sintered under a temperature condition of 400 to 500° C., the CO conversion is 80% to 100% in a temperature range of 290 to 350° C. in a SO₂ atmosphere. Preferably, when the catalyst is sintered under a temperature condition of 350 to 450° C., more preferably, when sintered under a temperature condition of 380 to 420° C., the CO conversion is 80% to 100% in a temperature range of 270 to 300° C.

In addition, when a catalyst using a metal sulfide and a catalyst using a conventional commercial AMT are compared, in order for the CO conversion to reach 80% or higher, a temperature of 270° C. or higher is required for the catalyst using a metal sulfide, and a temperature of 340° C. or higher is required for the catalyst using AMT. In other words, the catalyst using a metal sulfide achieves the CO conversion of 80% or more at a lower temperature.

The catalyst using a metal sulfide has a CO conversion of 80% to 100% in a temperature range of 270 to 350° C. under SO₂-on conditions, and the CO conversion already reaches about 100% at 280° C. Therefore, compared to the existing commercial catalysts that require heating at a high temperature of 350° C. or higher to achieve a CO conversion of 80% or more, the catalyst using a metal sulfide can oxidize CO even at a relatively low temperature of 270 to 300° C.

Hereinafter, in order to specifically explain this specification, examples will be given and described in detail. However, the examples according to this specification may be modified into various different forms, and the scope of this specification is not construed as being limited to the examples described below. The examples of this specification are provided to more completely explain this specification to a person having average knowledge in the art.

### EXAMPLES

### Example 1—Preparation of Catalyst Utilizing MS₂ (WS₂ and MoS₂) Precursor

### 1-1. Preparation of Reduction Catalyst

To prepare catalysts utilizing WS₂ and MoS₂ precursors, oxalic acid was dissolved in an ethanol solvent set at 60° C., and 2% by weight of ammonium metavanadate (AMV) was added to prepare solution 1. Solution 2 was prepared by dispersing WS₂ or MoS₂ in a fixed amount of 5% by weight in an ethanol solvent using tip sonication, and solution 3 was prepared by dispersing TiO₂ in a fixed amount of 93% in an ethanol solvent

Each of the prepared solutions was stirred for 30 minutes, and the solutions were mixed together and tip-sonicated for one hour to disperse and mix in a solvent. Thereafter, the mixture liquid was stirred for two hours, and the solvent was evaporated while stirring at approximately 100° C. using an oil bath. The completed cake form was dried at 100° C. for 12 hours to remove all residual moisture and then sintered under each temperature condition for two hours to prepare a powder catalyst.

### 1-2. Preparation of Oxidation Catalyst

An oxidation catalyst was prepared using the same impregnation method as the reduction catalyst, and TiO₂ was first dried at 100° C. for 12 hours to remove residual moisture and impurities before use. A fixed amount of TiO₂ was dispersed in a deionized (DI) solvent, and a fixed amount of Pt precursor was dissolved in a DI solvent, and the resulting mixture was stirred at 60° C. for two hours. Thereafter, a fixed amount of WS₂ was dispersed in DI water, and tip sonication was performed for 10 minutes to improve the dispersibility. All the separately prepared solutions were mixed, and tip sonication was performed for an additional hour, and then the resulting mixture was dried for 12 hours using an oil bath at 110° C. to remove residual moisture.

The prepared powder was sintered at 300, 400, and 500° C. for two hours to obtain powdered catalysts, and the WS₂-supported Pt/TiO₂ catalysts were named 0.1 Pt-xWS₂/TiO₂_y (x=3.6%, 5% by weight; y=300, 400, 500° C.).

### Example 2—Evaluation of Properties

### 2-1. Thermogravimetric Analysis (TGA)

In order to confirm the thermal decomposition behavior of the MS₂ precursor, the weight change was analyzed by increasing the temperature of the MoS₂ powder and the WS₂ powder from room temperature to 800° C. under air condition through TGA (SDT Q600, TA).

### 2-2. Experiment Before and After Heat Treatment at 500° C.

In order to confirm the extent of oxidation of the MS₂ precursor at 500° C., which is the sintering temperature condition of commercial catalysts, approximately 1 g of WS₂ or MoS₂ was added to a quartz boat, and then the temperature was increased to 500° C. at a heating rate of 5° C./min using a box-type high-temperature sintering furnace and maintained for approximately two hours. After the holding time was over, cooling was performed to recover the precursors at room temperature, and the samples before and after heat treatment were placed in vials, and the changes in the samples before and after heat treatment were visually analyzed.

### 2-3. X-Ray Diffractometry (XRD)

Samples of the MS₂ before and after heat treatment were recovered, and an XRD (ULTIMA 4, Rigaku) was performed to analyze the phase change. A small amount of powder was used, and the analysis was performed at a scan rate of 1°/min in the range of 2θ=10 to 90.

### Example 3—Evaluation of NOx Reduction Characteristics

3-1. Comparison of Catalyst Using WS₂ vs. Existing Catalyst Using Commercial AMT (Comparative Example)

The catalyst using WS₂ is 2V5W(WS₂)/TiO₂ (EtOH), and the existing catalyst using commercial AMT is 2V5W (AMT)/TiO₂ (DI).

TABLE 1
Analysis condition

| Total flow | 500 sccm | |
|---|---|---|
| Gas Condition | NH₃ | 300 ppm |
| | O₂ | 5% |
| | NOx | 300 ppm |
| | SO₂ | 0 or 300 ppm |
| | N₂ | Balance gas |

| | |
|---|---|
| GHSV | 60,000 h⁻¹ |

The NOx conversion characteristics were analyzed using the synthesized powder catalyst in the temperature range of 150 to 450° C., and the inlet and outlet concentrations of gases containing NOx, SO₂, NH₃, and O₂ were measured using a Fourier transform infrared (FT-IR) spectrometer and an oxygen analyzer. In all evaluations, stable results were measured by maintaining each temperature condition for more than 30 minutes, and the NOx conversion characteristics were analyzed by calculating the difference in the NOx concentration at the inlet and the outlet.

3-2. Comparison of Catalysts Using MS₂ (MoS₂, WS₂) Precursors by Sintering Temperature

In order to compare the sulfur resistance characteristics when using a MS₂ precursor, analyses were conducted in the temperature range of 150 to 450° C. in an SO₂-on atmosphere where SO₂ at a concentration of 300 ppm was injected and in an SO₂-off atmosphere where SO₂ was not injected. Since it took time until stabile activity was achieved, especially at low temperatures, the NOx conversion efficiency was calculated by measuring the outlet NOx concentration when the NOx emission level was stabilized while maintaining each temperature range for about 30 minutes.

### Example 4—Evaluation of CO Oxidation Characteristics

### 4-1. Activity Comparison According to the Catalyst Sintering Temperature

The reference catalyst prepared without using WS₂ was 0.1 Pt/TiO₂_Ref and sintered at 500° C. For activity comparison according to the sintering temperature, catalysts were prepared using WS₂ in the same amount of 5% by weight and sintered at 400 and 500° C., and the prepared catalysts were named as 0.1Pt-5WS₂/TiO₂_400 and 500.

The CO oxidation characteristics of the synthesized powder catalysts were analyzed in the temperature range of 200 to 350° C. All gases were supplied constantly through a mass flow controller (MFC), and the inlet and outlet concentrations of the gases containing CO, NOx, SO₂, and O₂ were measured using an FT-IR spectrometer and an oxygen analyzer. All evaluations were conducted for more than 30 minutes under each temperature condition, the same as the evaluation of the reduction catalyst, and stable results were measured. The co conversion characteristics were analyzed by calculating the difference in the Co concentration between the inlet and outlet. In addition, in order to compare the sulfur resistance properties of the catalyst using WS₂, the evaluation was conducted under SO₂-on/off conditions.

4-2. Comparison of CO Oxidation Characteristics of Catalyst Using WS₂ vs. Catalyst Using AMT

The catalyst prepared by using WS₂ was 0.1 Pt-3.6WS₂/TiO₂, and the catalyst prepared by using AMT was 0.1 Pt-3.6W (AMT)/TiO₂. For evaluation under the same conditions, 0.1 Pt/TiO₂_Ref and all catalysts were sintered at 500° C.

The CO oxidation characteristics of the synthesized powder catalysts were evaluated and analyzed under the same conditions as the activity evaluation according to the sintering temperature, and the evaluation was conducted only under conditions containing SO₂ to confirm the resistance to SO₂.

TABLE 2
CO oxidation analysis condition

| Total flow | 500 sccm | |
|---|---|---|
| Gas Condition | CO | 1% |
| | O₂ | 5% |
| | NOx | 300 ppm |
| | SO₂ | 0 or 100 ppm |
| | N₂ | Balance gas |

| | |
|---|---|
| GHSV | 60,000 h⁻¹ |

### Results and Evaluation

### Result 1—Property Evaluation

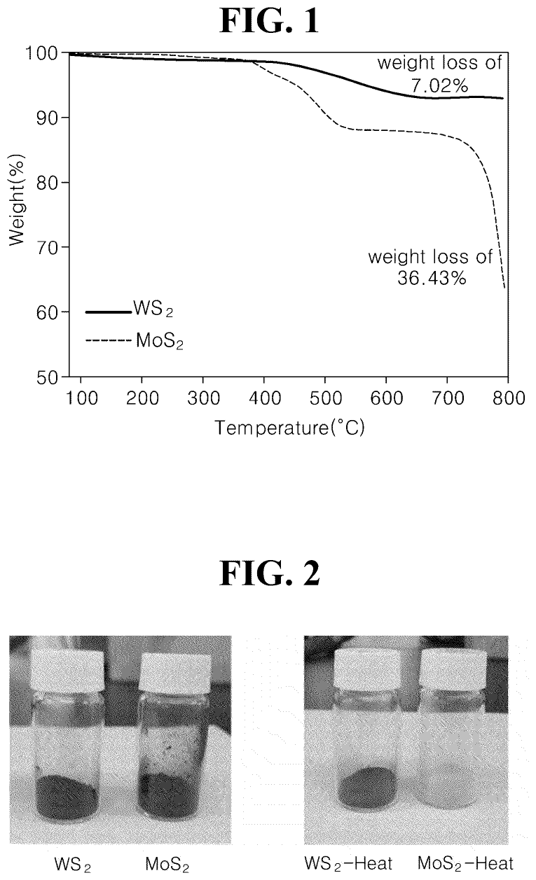

FIG. 1 shows the results of weight change according to the sintering temperature according to one embodiment of the present invention. Referring to FIG. 1, the TGA results obtained by analyzing the thermal decomposition behavior of the metal sulfide precursor under air condition in Example 2-1 show that MoS₂ began to undergo thermal decomposition at about 400° C., exhibiting a total weight loss of 36.43%, while WS₂ showed relatively high thermal stability and began to undergo thermal decomposition at about 450° C., exhibiting a total weight loss of 7%. Therefore, it was confirmed that an optimal catalyst could be prepared by finding the optimal coexistence form of sulfides and oxides through optimization of the catalyst sintering temperature at 300 to 500° C.

FIG. 2 shows an analysis of thermal decomposition behavior before and after heat treatment according to one embodiment of the present invention. Referring to FIG. 2, in order to confirm the thermal decomposition behavior of WS₂ and MoS₂ in Example 2-2, heat treatment was performed for two hours at 500° C., which is the condition for sintering mainly vanadium-based catalysts. As a result of heat treatment under the same conditions, it was visually confirmed that WS₂ underwent a slight color change and MoS₂ mostly turned white.

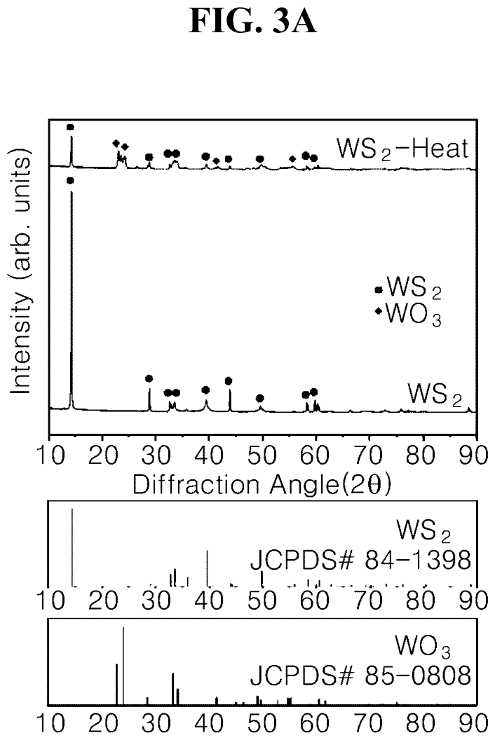

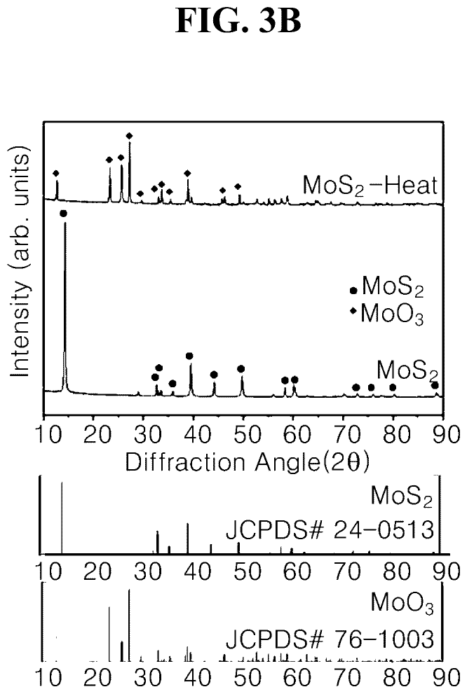

FIG. 3A and FIG. 3B show an analysis of phase change before and after heat treatment according to one embodiment of the present invention. Referring to FIG. 3A and FIG. 3B, the results obtained by performing an XRD phase analysis before and after heat treatment of WS₂ and MoS₂ in Example 2-3 showed that before heat treatment, each exhibited a high MS₂ crystal phase, and after WS₂ heat treatment, the sample had relatively high thermal stability, similar to the TGA results, so that WS₂ and WO₃ coexisted even after the heat treatment process at 500° C. (see FIG. 3A). In comparison, MoS₂ had relatively low thermal stability and was oxidized to MoO₃ when heat treated at 500° C., so it was confirmed that setting coexistence conditions is necessary (see FIG. 3B).

### Result 2—Evaluation of NOx Reduction Characteristics

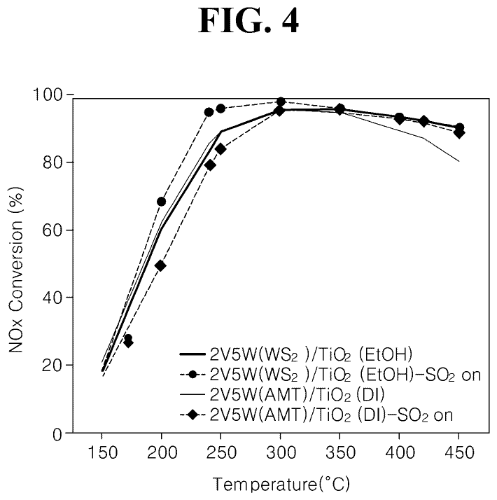

FIG. 4 shows the results of evaluating NOx reduction properties according to one embodiment of the present invention. Referring to FIG. 4, the results of evaluation of NOx reduction characteristics conducted in Example 3-1 were obtained by analyzing NOx conversion characteristics in a temperature range of 150 to 450° C. using a synthesized powder catalyst, and the inlet and outlet concentrations of gases containing NOx, SO₂, NH₃, and O₂ were measured using an FT-IR spectrometer and an oxygen analyzer. All evaluations were conducted for more than 30 minutes under each temperature condition to measure stable results, and the NOx conversion characteristics were analyzed by calculating the difference in NOx concentration at the inlet and outlet. As a result, it was found that the existing commercial catalyst using AMT exhibited reduction of the activity due to catalyst acid site poisoning at low temperatures under SO₂-on conditions, but the activity of the catalyst prepared by adding WS₂ was improved in the low-temperature range because it retained sulfur components on the surface. In particular, the NOx reduction rate was improved by 10% compared to the SO₂-off condition at 240° C.

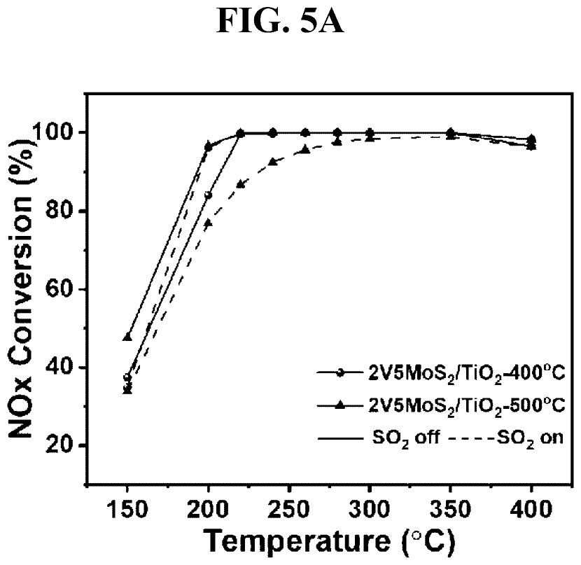

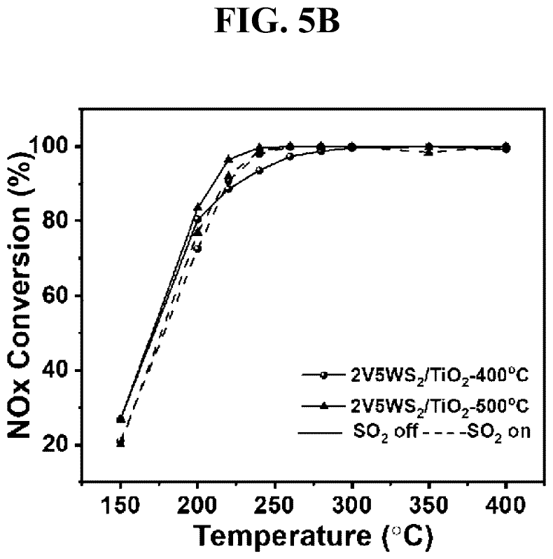

FIG. 5A and FIG. 5B show the results of evaluating NOx reduction properties according to the sintering temperature according to one embodiment of the present invention. FIG. 5A and FIG. 5B show the results for Example 3-2, and referring to FIG. 5A, MoS₂ also exhibited similar results, and the catalyst sintered at 400° C. exhibited improved catalytic efficiency under the SO₂-on condition over the entire temperature range. As a result, when the catalyst was sintered at 400° C. in order to confirm the effect of MS₂, the SO₂ resistance characteristics were confirmed, and the catalyst prepared by adding MoS₂ exhibited high NOX reduction characteristics overall.

Referring FIG. 5B, when comparing the catalysts prepared by adding WS₂, the catalyst prepared by adding WS₂ and sintered at 400° C. exhibited improved activity at a temperature 220° C. or higher, but the catalyst sintered at 500° C. did not exhibited a significant difference.

However, since MoS₂ causes a problem of converting NO to N₂O by one of the side reactions, N₂O generation may be a problem at a high temperature of 400° C., so it is necessary to select and apply WS₂ or MoS₂ depending on the applied temperature conditions.

### Result 3—Evaluation CO Oxidation Characteristics

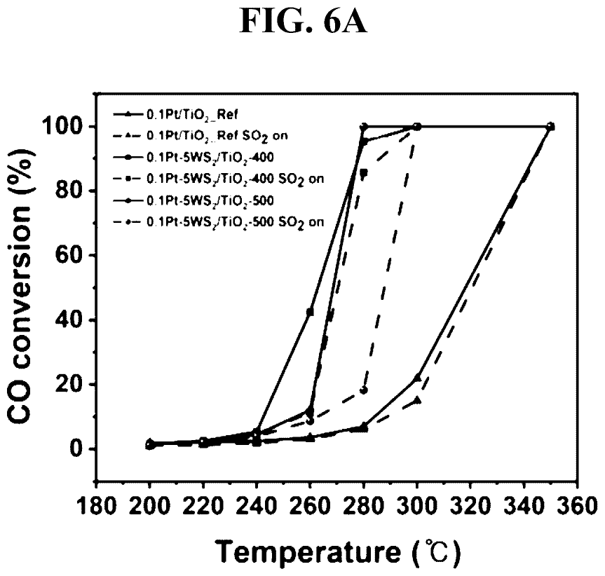

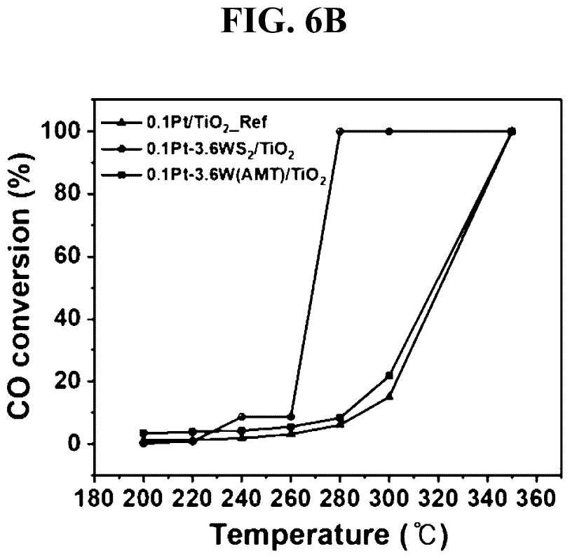

FIG. 6A and FIG. 6B show the results of evaluating CO oxidation properties according to the sintering temperature according to one embodiment of the present invention. Referring FIG. 6A, the co oxidation evaluation under the SO₂-on/off conditions performed in Example 4-1 showed that the reaction temperature range of both catalysts prepared by adding WS₂ was expanded and the catalyst sintered at 400° C. exhibited no significant deactivation even under the SO₂-on condition. Therefore, it was determined that the catalyst sintered at 400° C. had higher resistance to SO₂ because it had a phase where WS₂ and WO₃ coexisted. In general, the addition of W has a positive effect on the activity by preventing sintering of Pt and enhancing thermal and structural stability.

Referring to FIG. 6B, in order to confirm the sulfur resistance characteristics of WS₂ in Example 4-2, W precursors were synthesized using AMT and WS₂, and the CO oxidation activity was evaluated under SO₂-on condition. The catalyst prepared by adding WS₂ showed higher activity in an SO₂ atmosphere than the catalyst prepared by using AMT as a precursor. Therefore, it was determined that the catalyst prepared by adding WS₂ had higher sulfur resistance characteristics than the catalyst prepared by adding AMT.

The foregoing has slightly broadly described the features and technical advantages of the present invention so that the scope of the claims to be described later may be better understood. Those skilled in the art will understand that the present invention may be implemented in other specific forms without changing the technical idea or essential features thereof. Therefore, it should be understood that the above-described embodiments are exemplary in all respects and not restrictive. The scope of the present invention is indicated by the claims described below rather than the detailed description above, and all changes or modifications derived from the claims and their equivalents should be interpreted as being included in the scope of the present invention.

1. A method of preparing a reduction catalyst utilizing a sulfur element-containing precursor, the method comprising:
(a) a first step of preparing a mixture liquid (solution 1) containing a vanadium precursor;
(b) a second step of preparing a metal sulfide dispersion (solution 2);
(c) a third step of preparing a TiO₂ dispersion (solution 3);
(d) a fourth step of mixing solutions 1 to 3 and then removing moisture through stirring and drying; and
(e) a fifth step of conducting sintering.

2. The method of preparing the reduction catalyst utilizing the sulfur element-containing precursor according to claim 1, wherein in Step (b), the metal sulfide is one or more selected from metal sulfide precursors.

3. The method of preparing the reduction catalyst utilizing the sulfur element-containing precursor according to claim 1, wherein in Step (d), the mixing is carried out by ultrasonic treatment to disperse in a solvent.

4. The method of preparing the reduction catalyst utilizing the sulfur element-containing precursor according to claim 1, wherein in Step (e), the sintering is carried out for one to three hours.

5. A sulfur element-containing reduction catalyst according to the preparation method of claim 1.

6. A method of preparing an oxidation catalyst utilizing a sulfur element-containing precursor, the comprising:
(a) a first step of preparing a TiO₂ dispersion and;
(b) a second step of adding a main catalyst to the dispersion and stirring the resulting dispersion;
(c) a third step of adding a metal sulfide to the stirred dispersion and mixing the resulting mixture; and
(d) a fourth step of drying and sintering the mixture.

7. The method of preparing the oxidation catalyst utilizing the sulfur element-containing precursor according to claim 6, wherein in Step (c), the metal sulfide is one or more selected from metal sulfide precursors.

8. The method of preparing the oxidation catalyst utilizing the sulfur element-containing precursor according to claim 6, wherein in Step (d), the sintering is carried out for one to three hours.

9. A sulfur element-containing oxidation catalyst according to the preparation method of claim 6.
